(19) United States
(12) Patent Application Publication
(10) Pub. No.: US 2006/0087403 A1
(43) Pub. Date: Apr. 27, 2006

(54) Keyless entry system, transmitter, and receiver

(75) Inventors: Hiroya Yamamoto, Gunma-ken (JP); Masahiro Umewaka, Ota-shi (JP); Shinji Osugi, Gunma-ken (JP); Kazumasa Chigira, Kiryu-shi (JP); Akira Iketani, Ota-shi (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 11/255,244

(22) Filed: Oct. 20, 2005

(30) Foreign Application Priority Data
Oct. 21, 2004 (JP) 2004-306851

(51) Int. Cl. H04L 9/32

(52) U.S. Cl. 340/5.26; 340/5.27; 340/5.64; 340/5.21

(57) ABSTRACT

A keyless entry system comprising a transmitter and a receiver. The transmitter increases a first number stored in the volatile memory according to rules, and transmits the first number by radio. The receiver receives the first number, and if the first number is greater than a second number stored in a memory, outputs a signal to indicate being authenticated as correct and updates the second number to the first number. Further, each time increase in the first number becomes a multiple of a predetermined number, the transmitter writes into a non-volatile memory a third number equal to the predetermined number plus the first number. When the first number in the volatile memory is erased due to the exchange, etc., of the battery, the transmitter reads out the third number from the non-volatile memory and writes the third number as the first number into the volatile memory.

### CROSS-REFERENCE TO RELATED APPLICATIONS

The present application claims priority from Japanese Patent Application No. 2004-306851 filed on Oct. 21, 2004, which is herein incorporated by reference.

### BACKGROUND OF THE INVENTION

1. Field of the Invention

The present invention relates to a keyless entry system which is used to lock and unlock locks of vehicles, houses, and the like.

2. Description of the Related Art

In recent years, in various sectors such as vehicles and houses, keyless entry systems have been adopted. Such a keyless entry system comprises a mobile transmitter and a receiver mounted in a vehicle or the like. The transmitter transmits a signal by radio to the receiver to lock and unlock the lock.

In this keyless entry system, a rolling code or the like is used for signals transmitted from the transmitter to the receiver, thus improving security. The rolling code is stored in a non-volatile memory such as a flash memory provided in the transmitter, and updated each time transmitted. See Japanese Patent Application Laid-Open Publication No. 2000-314252. By this means, it is possible to prevent the locking and unlocking of the lock with an unauthorized signal from a learning remote control or the like.

In order to update the rolling code in the non-volatile memory each time transmitted as mentioned above, the memory has to be able to be rewritten about one hundred thousand times assuming the actual duration of use of 10 years. Accordingly, physical measures are taken such as configuring the non-volatile memory to have pages in plurality or configuring each bit to have two cells.

However, implementing such physical measures on non-volatile memories causes their chip area and thus the costs of the transmitters to increase.

### SUMMARY OF THE INVENTION

The present invention was made in view of the above problem. An object of the invention is to reduce the number of times to write into the non-volatile memory provided in a transmitter, so that physical measures for the non-volatile memory are made unnecessary, thus suppressing production cost of the transmitter.

To achieve the above and other objects, a keyless entry system of one aspect of the present invention comprises a transmitter including a volatile memory, an authentication number update section that increases a first number stored in the volatile memory according to rules, and an authentication number transmit section that transmits the first number by radio, and a receiver including a memory that stores a second number, an authentication number receive section that receives the first number; and an authenticating section that, if the first number is greater than the second number, outputs a signal to indicate being authenticated as correct and updates the second number to the first number. The transmitter further includes a non-volatile memory, a backup section that, each time increase in the first number becomes a multiple of a predetermined number, writes into the non-volatile memory a third number obtained by adding a number no less than the predetermined number to the first number, and an authentication number restore section that reads out the third number and writes the third number as the first number into the volatile memory.

A keyless entry system of another aspect of the present invention comprises a transmitter including a volatile memory, an authentication number update section that decreases a first number stored in the volatile memory according to rules, and an authentication number transmit section that transmits the first number by radio; and a receiver including a memory that stores a second number, an authentication number receive section that receives the first number, and an authenticating section that, if the first number is less than the second number, outputs a signal to indicate being authenticated as correct and updates the second number to the first number. The transmitter further includes a non-volatile memory, a backup section that, each time decrease in the first number becomes a multiple of a predetermined number, writes into the non-volatile memory a third number obtained by subtracting a number no less than the predetermined number from the first number, and an authentication number restore section that reads out the third number and writes the third number as the first number into the volatile memory.

The transmitter of one aspect of the present invention used in the keyless entry system includes the volatile memory, the authentication number update section; the authentication number transmit section, the non-volatile memory, the backup section, and the authentication number restore section.

The receiver of one aspect of the present invention used in the keyless entry system includes the memory, the authentication number receive section, and the authenticating section.

A keyless entry system of further aspect of the present invention comprises a transmitter and a receiver which can communicate with each other by radio. The transmitter includes a volatile memory, an authentication number transmit section that transmits the first number stored in the volatile memory by radio, an authentication completion signal receive section that receives an authentication completion signal to indicate being authenticated as correct which has been transmitted thereto by radio in response to the first number transmitted, an authentication number update section that increases the first number by a predetermined increment in response to the authentication completion signal, a non-volatile memory, a backup section that, each time increase in the first number becomes a multiple of a predetermined number, writes into the non-volatile memory a third number obtained by adding the predetermined number to the first number, and an authentication number restore section that reads out the third number and writes the third number as the first number into the volatile memory. The receiver includes a memory that stores a second number, an authentication number receive section that receives the first number, an authentication number compute section that computes a fourth number equal to the minimum of possible values of the third number which are greater than the second number and writes the fourth number into the memory, an authentication completion signal transmit section that, if the first number is greater by the increment than the second number or the fourth number, transmits the authentication completion signal by radio, and an authenticating section that, if the first number is greater by the increment than the second number or the fourth number, outputs a signal to indicate being authenticated as correct and updates the second number to the first number.

A keyless entry system of yet further aspect of the present invention comprises a transmitter and a receiver which can communicate with each other by radio. The transmitter includes a volatile memory, an authentication number transmit section that transmits the first number stored in the volatile memory by radio, an authentication completion signal receive section that receives an authentication completion signal to indicate being authenticated as correct which has been transmitted thereto by radio in response to the first number transmitted, an authentication number update section that decreases the first number by a predetermined decrement in response to the authentication completion signal, a non-volatile memory; a backup section that, each time decrease in the first number becomes a multiple of a predetermined number, writes into the non-volatile memory a third number obtained by subtracting the predetermined number from the first number, and an authentication number restore section that reads out the third number and writes the third number as the first number into the volatile memory. The receiver includes a memory that stores a second number, an authentication number receive section that receives the first number, an authentication number compute section that computes a fourth number equal to the maximum of possible values of the third number which are less than the second number and writes the fourth number into the memory, an authentication completion signal transmit section that, if the first number is less by the decrement than the second number or the fourth number, transmits the authentication completion signal by radio, and an authenticating section that, if the first number is less by the decrement than the second number or the fourth number, outputs a signal to indicate being authenticated as correct and updates the second number to the first number.

The transmitter of another aspect of the present invention used in the keyless entry system includes the volatile memory, the authentication number transmit section, the authentication completion signal receive section, the authentication number update section, the non-volatile memory, the backup section, and the authentication number restore section.

The receiver of another aspect of the present invention used in the keyless entry system includes the memory, the authentication number receive section, the authentication number compute section, the authentication completion signal transmit section, and the authenticating section.

Features and objects of the present invention other than the above will become apparent from the description of this specification and the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a block diagram showing the configuration of a keyless entry system of a first implementation;

FIG. 2 is a block diagram showing the function of a transmitter of the first implementation;

FIG. 3 is a diagram showing the configuration of a transmit code of the first implementation and a second implementation;

FIG. 4 is a block diagram showing the function of a receiver of the first implementation;

FIG. 5 is a flow chart showing the process executed in the transmitter of the first implementation;

FIG. 6 is a flow chart showing the process executed in the receiver of the first implementation;

FIG. 7 is a block diagram showing the configuration of a keyless entry system of the second implementation;

FIG. 8 is a block diagram showing the function of a transmitter of the second implementation;

FIG. 9 is a block diagram showing the function of a receiver of the second implementation;

FIG. 10 is a flow chart showing the process executed in the transmitter of the second implementation;

FIG. 11 is a flow chart showing the process executed in the receiver of the second implementation; and

FIG. 12 is a flow chart showing the process of re-setting a rolling code in the transmitter of the second implementation.

### DETAILED DESCRIPTION OF THE INVENTION

At least the following matters will be made clear by the explanation in the present specification and the description of the accompanying drawings.

<<First Implementation>>

==Entire Configuration==

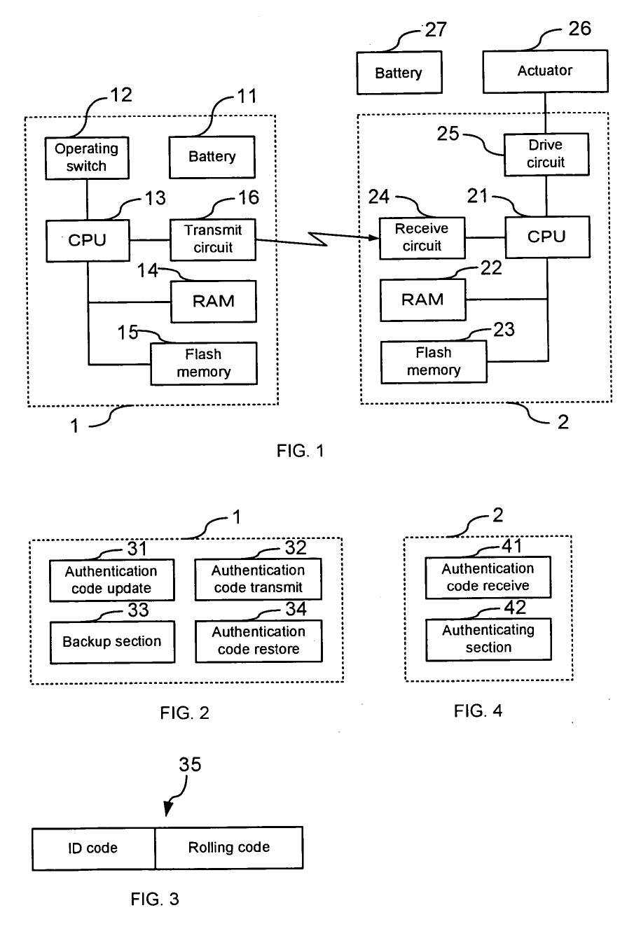

A keyless entry system for locking and unlocking the lock of a vehicle according to a first implementation of the present invention will be described. FIG. 1 is a block diagram showing the configuration of the keyless entry system of the first implementation. The keyless entry system comprises a transmitter 1 and a receiver 2. The transmitter 1 is provided in, for example, the handle of a key to be inserted into the key hole of a door lock or the steering lock of a vehicle, or the like. The receiver 2 is provided in, for example, the vicinity of the inner mirror of the vehicle or the like.

The transmitter 1 comprises a battery 11, an operating switch 12, a CPU 13, a RAM (Random Access Memory) 14, a flash memory 15, and a transmit circuit 16.

The battery 11 is for supplying electric power necessary for various parts of the transmitter 1 to operate. The operating switch 12 is a switch that accepts an instruction to lock and unlock from the user. The CPU 13 controls the transmitter 1 overall.

The RAM 14 stores work data and the like used by the CPU 13. The rolling code to be transmitted from the transmitter 1 to the receiver 2 is also stored in the RAM 14. In the present implementation, the initial value of the rolling code is “0”, and each time the operating switch 12 is operated, the rolling code is counted up (incremented) by one. The RAM 14, which is a volatile memory, is supplied with electric power from the battery 11 regardless of the operation of the operating switch 12.

The flash memory 15 is a rewritable non-volatile memory, and stores programs, data being preserved, and the like. Note that a ROM (Read-Only Memory) may be provided separately for storing the programs without the flash memory 15 storing them. The transmit circuit 16 is a circuit that converts digital data into analog data and amplifies the analog data and transmits in the form of an electromagnetic wave. An electrical wave or infrared light is used as the electromagnetic wave.

The receiver 2 comprises a CPU 21, a RAM 22, a flash memory 23, a receive circuit 24, and a drive circuit 25.

The CPU 21 controls the receiver 2 overall. The RAM 22 stores work data and the like used by the CPU 21. The flash memory 23 is a rewritable non-volatile memory, and stores programs, data being preserved, and the like. The flash memory 23 stores the rolling code received from the transmitter 1 the last time as well. Note that a ROM may be provided separately for storing the programs without the flash memory 23 storing them. The receive circuit 24 is a circuit that receives the electromagnetic wave transmitted by the transmitter 1, converts into digital data, and inputs the digital data into the CPU 21. The drive circuit 25 sends a drive signal to an actuator 26 to activate a lock mechanism to lock and unlock the lock of the vehicle. Note that the parts 21 to 25 of the receiver 2 are supplied with electric power from a battery 27 of the vehicle.

(2) Function Configuration

Next, the functions of the transmitter 1 and the receiver 2 will be described. FIG. 2 is a block diagram showing the functions possessed by the transmitter 1. The transmitter 1 comprises an authentication code update section (authentication number update section) 31, an authentication code transmit section (authentication number transmit section) 32, a backup section 33, and an authentication code restore section (authentication number restore section) 34. The authentication code update section 31, the backup section 33, and the authentication code restore section 34 are realized by the CPU 13 executing programs stored in the flash memory 15. The authentication code transmit section 32 is realized by the CPU 13 executing a program stored in the flash memory 15 using the transmit circuit 16.

The authentication code update section 31 counts up by one (or add one to) the rolling code (a first number) stored in the RAM 14. The authentication code transmit section 32 generates a transmit code 35 shown in FIG. 3, and transmits the code 35 to the receiver 2. The transmit code 35 contains an identification code and the rolling code. The identification code is a code for the receiver 2 to identify the transmitter 1 with and is stored in the flash memory 15.

In case the rolling code stored in the RAM 14 is lost due to the draining, exchange, or the like of the battery 11, the backup section 33 stores the rolling code in the flash memory 15. The authentication code restore section 34 loads the rolling code from the flash memory 15 into the RAM 14 upon the reset of the CPU 13 associated with voltage reduction due to the draining of the battery 11 or the exchange of the battery 11.

FIG. 4 is a block diagram showing the functions possessed by the receiver 2. The receiver 2 comprises an authentication code receive section (authentication number receive section) 41 and an authenticating section 42. The authentication code receive section 41 is realized by the CPU 21 executing a program stored in the flash memory 23 using the receive circuit 24. The authenticating section 42 is realized by the CPU 21 executing a program stored in the flash memory 23.

The authentication code receive section 41 receives the transmit code transmitted by the transmitter 1. The authenticating section 42 compares the rolling code set in the transmit code and the rolling code (a second number) received the preceding time and stored in the flash memory 23, and if the rolling code just received is greater than the rolling code received the preceding time, the authenticating section 42 realizes that a correct rolling code has been transmitted thereto, and sends an instruction signal to lock and unlock to the actuator 26 via the drive circuit 25. Then, the authenticating section 42 stores the just received rolling code in the flash memory 23, which is stored in association with the identification code of the transmitter 1 in the flash memory 23.

==Description of Processes==

Next, the processes performed in the keyless entry system of the implementation will be described using flow charts.

(1) Process by Transmitter

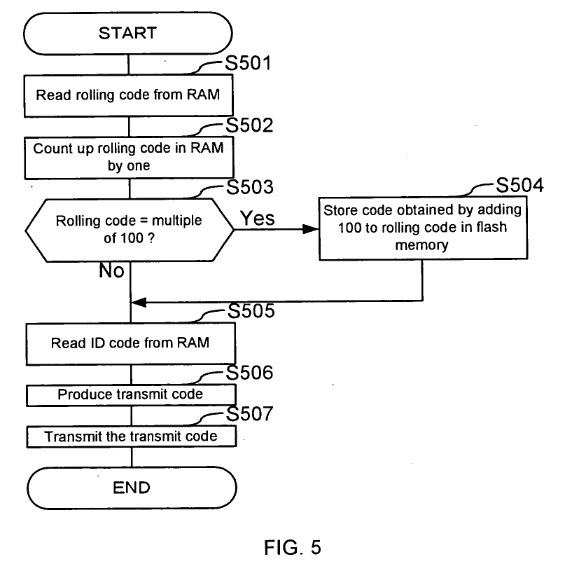

FIG. 5 is a flow chart showing the process performed by the transmitter 1. When the operating switch 12 is operated, the authentication code update section 31 reads out the rolling code stored in the RAM 14 (S501), and counts up the rolling code by one (S502). Then, if the rolling code counted up by one is a multiple of 100 (S503: YES), a rolling code (third number) obtained by adding 100 to the rolling code stored in the RAM 14 is stored in the flash memory 15 (S504).

Next, the authentication code transmit section 32 reads out the identification code that has been loaded from the flash memory 15 into the RAM 14 (S505), and produces a transmit code having this code together with the rolling code (S506). Then, the authentication code transmit section 32 transmits the transmit code to the receiver 2 (S507).

That is, in the present implementation, each 100th time that the rolling code stored in the RAM 14 is counted up by one, a rolling code obtained by adding 100 to the rolling code in the RAM 14 is backed up in the flash memory 15.

Suppose that the rolling code stored in the RAM 14 has been erased due to the draining, exchange, or the like of the battery 11. In this case, once the CPU 13 is reset, the authentication code restore section 34 loads the rolling code stored in the flash memory 15 into the RAM 14. Thus, the rolling code loaded from the flash memory 15 into the RAM 14 is greater than the rolling code stored in the RAM 14 immediately before the erasing.

(2) Process by Receiver

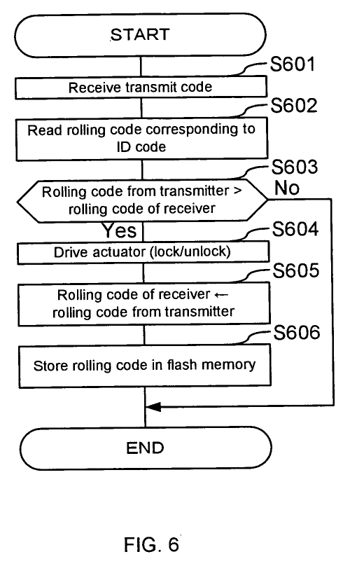

FIG. 6 is a flow chart showing the process performed by the receiver 2. First, the authentication code receive section 41 receives the transmit code transmitted by the transmitter 1 (S601). Then, the authenticating section 42 reads out the rolling code corresponding to the identification code set in the transmit code from the RAM 22 (S602). If the rolling code from the transmitter 1 is greater than the rolling code held in the receiver 2 (S603: YES), the authenticating section 42 realizes that a correct rolling code has been transmitted thereto, and sends a drive signal to the actuator 26 (S604). Further, the authenticating section 42 sets the rolling code received from the transmitter 1 to the rolling code in the RAM 22 (S605) and stores the received rolling code in the flash memory 23 (S606).

As such, if a rolling code greater than the rolling code held in the receiver 2 has been transmitted thereto, the receiver 2 authenticates the rolling code as a correct one. Hence, even when only the rolling code of the transmitter 1 is counted up by operating the operating switch 12 of the transmitter 1 outside the receivable range of the receiver 2 (useless pressing), the rolling code transmitted from the transmitter 1 thereafter is authenticated as correct. Also, even when the rolling code in the RAM 14 of the transmitter 1 is lost, the rolling code restored from the flash memory 15 thereto is greater than the rolling code held in the receiver 2, and thus authenticated as correct.

<<Second Implementation>>

==Entire Configuration==

(1) Hardware Configuration

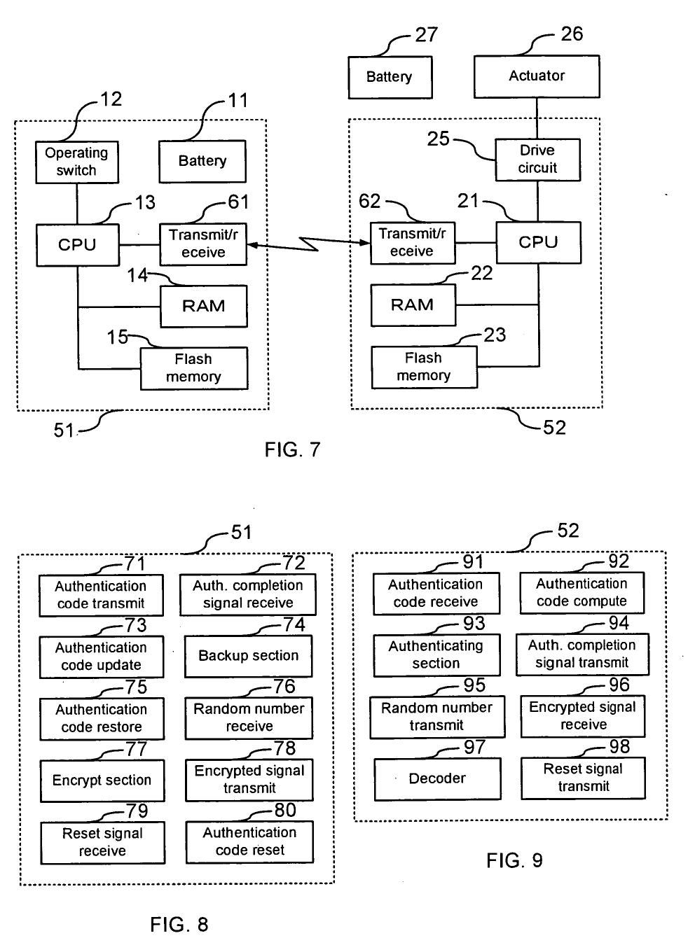

Next, a keyless entry system that is a second implementation of the present invention will be described. FIG. 7 is a block diagram showing the configuration of the keyless entry system of the second implementation. The keyless entry system of this implementation comprises a transmitter 51 and a receiver 52. The transmitter 51 is the same as the transmitter 1 of the first implementation except having a transmit/receive circuit 61 instead of the transmit circuit 16. The receiver 52 is the same as the receiver 2 of the first implementation except having a transmit/receive circuit 62 instead of the receive circuit 24. The transmit/receive circuits 61, 62 are each a circuit having both the functions of the transmit circuit 16 and the receive circuit 24. That is, the transmitter 51 and the receiver 52 can transmit/receive electromagnetic waves to/from each other via the transmit/receive circuits 61, 62. The other part of the configuration is the same as that of the first implementation.

(2) Function Configuration

Next, the functions possessed by the transmitter 51 and the receiver 52 will be described. FIG. 8 is a block diagram showing the functions of the transmitter 51. The transmitter 51 comprises an authentication code transmit section (authentication number transmit section) 71, an authentication completion signal receive section 72, an authentication code update section (authentication number update section) 73, a backup section 74, an authentication code restore section (authentication number restore section) 75, a random number receive section 76, an encrypt section 77, an encrypted signal transmit section 78, a reset signal receive section 79, and an authentication code reset section 80. The authentication code transmit section 71, the authentication completion signal receive section 72, the random number receive section 76, the encrypted signal transmit section 78, and the reset signal receive section 79 are realized by the CPU 13 executing programs stored in the flash memory 15 using the transmit/receive circuit 61. The authentication code update section 73, the backup section 74, the authentication code restore section 75, the encrypt section 77, and the authentication code reset section 80 are realized by the CPU 13 executing programs stored in the flash memory 15.

The authentication code transmit section 71 reads out the identification code and the rolling code (a first number) from the RAM 14, and generates the transmit code and transmits the transmit code to the receiver 52. The authentication completion signal receive section 72 receives an authentication completion signal transmitted thereto from the receiver 52 in response to the transmit code transmitted. The authentication code update section 73 counts up by one the rolling code stored in the RAM 14.

The backup section 74 stores the rolling code in the flash memory 15. The authentication code restore section 75 loads the rolling code in the flash memory 15 into the RAM 14 upon the reset of the CPU 13 associated with voltage reduction due to the draining of the battery 11 or the exchange of the battery 11.

The random number receive section 76 receives a random number signal transmitted thereto from the receiver 52 and having a random number set therein. The encrypt section 77 encrypts the random number set in the random number signal according to rules preset between the transmitter 51 and the receiver 52. The encrypted signal transmit section 78 transmits an encrypted signal that is a signal having the random number encrypted by the encrypt section 77 set therein to the receiver 52. The reset signal receive section 79 receives a reset signal transmitted thereto from the receiver 52 in response to the encrypted signal. The authentication code reset section 80 writes the rolling code set in the reset signal into the RAM 14 and the flash memory 15.

FIG. 9 is a block diagram showing the functions possessed by the receiver 52. The receiver 52 comprises an authentication code receive section (authentication number receive section) 91, an authentication code compute section (authentication number compute section) 92, an authenticating section 93, an authentication completion signal transmit section 94, a random number transmit section 95, an encrypted signal receive section 96, a decoder 97, and a reset signal transmit section 98. The authentication code receive section 91, the authentication completion signal transmit section 94, the random number transmit section 95, the encrypted signal receive section 96, and the reset signal transmit section 98 are realized by the CPU 21 executing programs stored in the flash memory 23 using the transmit/receive circuit 62. The authentication code compute section 92, the authenticating section 93, and the decoder 97 are realized by the CPU 21 executing programs stored in the flash memory 23.

The authentication code receive section 91 receives the transmit code transmitted thereto from the transmitter 51. The authentication code compute section 92 calculates the rolling code (a third number) backed up in the flash memory 15 of the transmitter 51 based on the rolling code stored in the flash memory 23, and stores the calculated rolling code as a work code (a fourth number) in the RAM 22.

The authenticating section 93 compares the rolling code set in the transmit code and the rolling code (a second number) received the preceding time and stored in the flash memory 23 and the work code stored in the RAM 22. Then, if the rolling code just received is greater by one than the rolling code received the preceding time or the work code, the authenticating section 93 realizes that a correct rolling code has been transmitted thereto. In this case, the authenticating section 93 sends an instruction signal to lock and unlock to the actuator 26 via the drive circuit 25, and stores the just received rolling code in the flash memory 23. Then, the authentication completion signal transmit section 94 transmits an authentication completion signal indicating that the authenticating section 93 has authenticated the transmitter 51 as correct to the transmitter 51.

That is, in the keyless entry system of the present implementation, the transmitter 51 and the receiver 52 update the rolling codes cooperatively by communicating with each other. Thus, even if the operating switch 12 is pressed uselessly, it does not happen that only the rolling code of the transmitter 51 is updated. Hence, as mentioned above, if the rolling code just received is greater by one than the rolling code received the preceding time, the authenticating section 93 authenticates the rolling code as correct. Furthermore, the rolling code stored in the flash memory 15 is used by the transmitter 51 if the draining, the exchange, or the like of the battery 11 occurs. Accordingly, if greater by one than the work code, the rolling code is authenticated as correct.

When the authenticating section 93 has not authenticated the rolling code as correct, the random number transmit section 95 generates a random number and transmits to the transmitter 51 a random number signal having the random number set therein. The encrypted signal receive section 96 receives an encrypted signal transmitted from the transmitter 51 in response to the random number signal. The decoder 97 decodes the encrypted signal according to rules preset between the transmitter 51 and the receiver 52. If the signal decoded by the decoder 97 matches the random number transmitted by the random number transmit section 95, the reset signal transmit section 98 transmits to the transmitter 51 a reset signal having the rolling code from the flash memory 23 set therein.

That is, if the rolling code is not authenticated as correct, authentication for the transmitter 51 is tried through a prescribed encrypt-and-decode process between the transmitter 51 and the receiver 52. If the transmitter 51 is authenticated as correct, the rolling code of the transmitter 51 is re-set to the rolling code of the receiver 52. By this means, it is prevented that the authenticating section 93 can not authenticate the transmitter 51 as correct even if the transmitter 51 is a correct one. For example, if the transmitter 51 has not been able to receive the authentication completion signal transmitted from the receiver 52, only the rolling code of the receiver 52 is updated and thereafter the transmitter 51 is not authenticated as correct. In such cases, because the rolling code is reset, the transmitter 51 gets authenticated as correct.

==Description of Processes==

Next, the processes performed in the keyless entry system of the implementation will be described using flow charts.

(1) Process by Transmitter

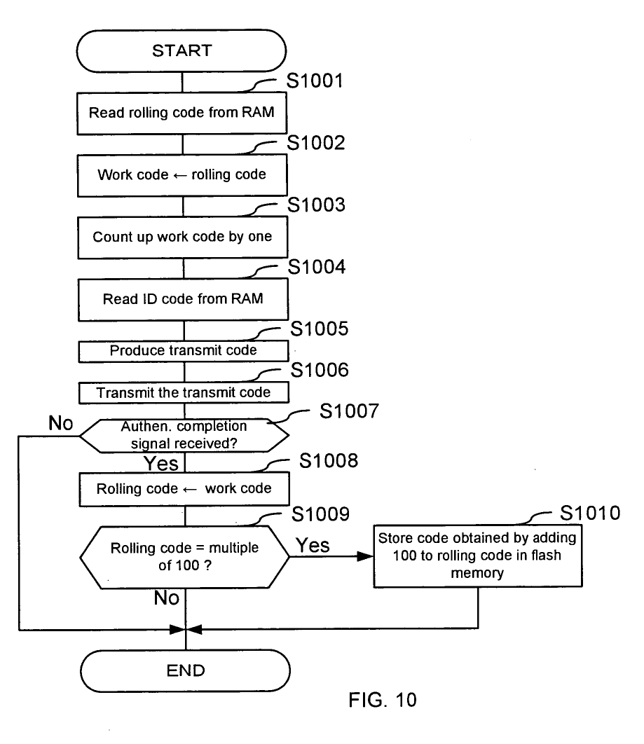

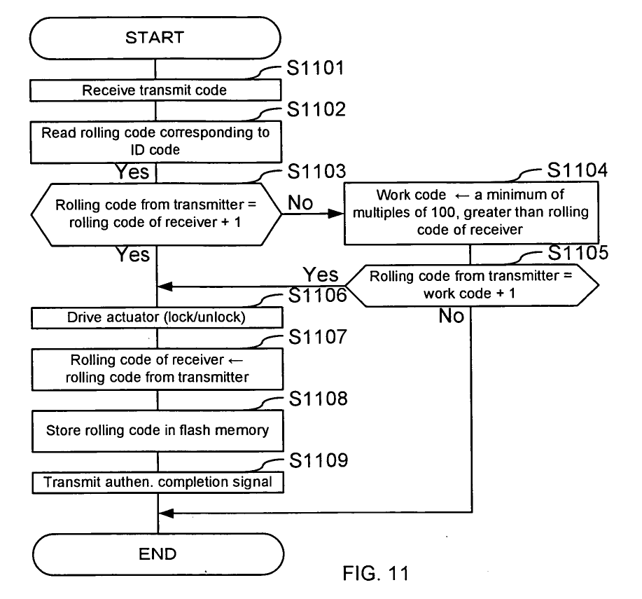

FIG. 10 is a flow chart showing the process performed by the transmitter 51. When the operating switch 12 is operated, the authentication code transmit section 71 reads out the rolling code stored in the RAM 14 (S1001). Then, the authentication code transmit section 71 sets the rolling code stored in the RAM 14 to a work code (S1002), and counts up by one (adds one to) the work code (S1003). Next, the authentication code transmit section 71 reads out the identification code that has been loaded from the flash memory 15 into the RAM 14 (S1004), and produces a transmit code having this code together with the rolling code (S1005). Then, the authentication code transmit section 71 transmits the transmit code to the receiver 52 (S1006).

Thereafter, when the authentication completion signal receive section 72 has received the authentication completion signal transmitted from the receiver 52 (S1007: YES), the authentication code update section 73 overwrites the work code onto the rolling code stored in the RAM 14 (S1008). That is, the authentication code update section 73 counts up by one the rolling code in the RAM 14 in response to the authentication completion signal. Note that if the authentication completion signal has not been received within a prescribed time period (S1009: NO), the rolling code in the RAM 14 is not updated. Thus, even if the operating switch 12 of the transmitter 51 is pressed uselessly, the rolling code is not counted up.

If the rolling code counted up is a multiple of 100 (S1009: YES), the backup section 74 stores in the flash memory 15 a rolling code obtained by adding 100 to the rolling code stored in the RAM 14 (S1010).

Further, as described previously, the authentication code restore section 75 loads the rolling code from the flash memory 15 into the RAM 14 upon the reset of the CPU 13 associated with the draining, the exchange, or the like of the battery 11.

(2) Process by Receiver

FIG. 11 is a flow chart showing the process performed by the receiver 52. First, the authentication code receive section 91 receives the transmit code transmitted by the transmitter 51 (S1101). Then, the authenticating section 93 reads out from the RAM 22 the rolling code (a third authentication code) corresponding to the identification code set in the transmit code (S1102). If the rolling code from the transmitter 51 is greater by one than the rolling code held in the receiver 52 (S1103: YES), the authenticating section 93 realizes that a correct rolling code has been transmitted thereto.

If this condition is not satisfied (S1103: NO), the authentication code compute section 92 computes a minimum of codes that are greater than the rolling code read from the RAM 22 and that are a multiple of 100, and sets the minimum to a work code (S1104). That is, the work code is equal to the rolling code backed up in the flash memory 15 of the transmitter 51. And if the rolling code from the transmitter 51 is greater by one than the work code (S1105: YES), the authenticating section 93 realizes that a correct rolling code has been transmitted thereto.

If either of these two conditions is satisfied (S1103: YES or S1105: YES), the authenticating section 93 sends a drive signal to the actuator 26 (S1106). Furthermore, the authenticating section 93 sets the rolling code received from the transmitter 51 to the rolling code in the RAM 22 (S1107) and stores the received rolling code in the flash memory 23 (S1108). Then, the authentication completion signal transmit section 94 transmits to the transmitter 51 an authentication completion signal to indicate being authenticated as correct (S1109).

(3) Reset Process

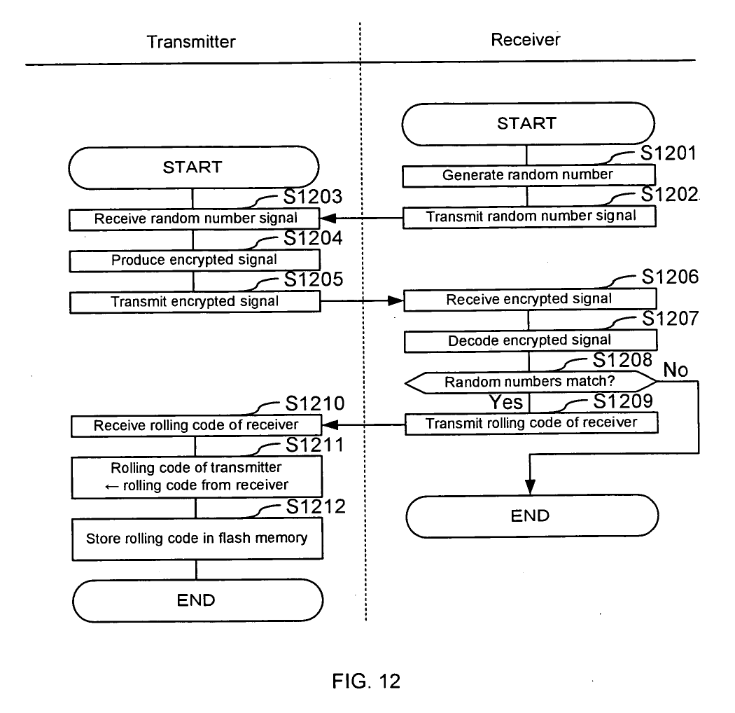

FIG. 12 is a flow chart showing the process of re-setting the rolling code in the transmitter 51. This process is executed when in the process of FIG. 11 the rolling code from the transmitter 51 has not been authenticated as correct (S1105: NO).

First, the random number transmit section 95 of the receiver 52 generates a random number (S1201) and transmits a random number signal having the random number set therein to the transmitter 51 (S1202).

The random number receive section 76 of the transmitter 51 receives the random number signal (S1203). Then, the encrypt section 77 encrypts the random number set in the random number signal according to rules preset between the transmitter 51 and the receiver 52 thereby producing an encrypted signal (S1204). Next, the encrypted signal transmit section 78 transmits the encrypted signal to the receiver 52 (S1205).

The encrypted signal receive section 96 of the receiver 52 receives the encrypted signal transmitted thereto from the transmitter 51 (S1206). Then, the decoder 97 decodes the encrypted signal according to rules preset between the transmitter 51 and the receiver 52 (S1207). If the signal decoded by the decoder 97 matches the random number transmitted by the random number transmit section 95 (S1208: YES), the reset signal transmit section 98 generates a reset signal having the rolling code from the flash memory 23 set therein and transmits the reset signal to the transmitter 51 (S1209).

The reset signal receive section 79 of the transmitter 51 receives the reset signal transmitted thereto from the receiver 52 (S1210). Then, the authentication code reset section 80 updates the rolling code stored in the RAM 14 and the flash memory 15 to the rolling code set in the reset signal (S1211, S1212).

By this means, the rolling code stored in the RAM 14 and the flash memory 15 of the transmitter 51 matches the rolling code stored in the RAM 22 and the flash memory 23 of the receiver 52. And the next time that the transmitter 51 transmits the rolling code, the receiver 52 authenticates the transmitter 51 as correct.

Note that the receiver 52 may be arranged to control a vehicle-mounted alarm device thereby sounding an alarm if the encrypted signal transmitted from the transmitter 51 is unauthentic (S1208: NO). Alternatively, the receiver 52 may be arranged to transmit an alarm signal having the identification code of the transmitter 51 set therein, and the true transmitter 51 may be arranged to receive the alarm signal to output an alarm sound, for example. By this means, unauthorized unlocking by a third party, so-called hacking, can be handled.

The keyless entry systems of the first and second implementations have been described above. In the transmitter 1 of the first implementation, the rolling code is written into the flash memory (non-volatile memory) 15 not each time but each predetermined number of (100) times. By this means, the number of times to write into the flash memory can be reduced which has an upper limit to the number of write times.

Furthermore, each predetermined number of times that the rolling code stored in the RAM (volatile memory) 14 is updated, the rolling code that has been further updated a prescribed number of times is written into the flash memory 15. If the rolling code stored in the RAM 14 is erased due to the draining, the exchange, or the like of the battery 11, the rolling code stored in the flash memory 15 is written into the RAM 14. By this means, the rolling code transmitted from the transmitter 1 is always greater than the rolling code held by the receiver 2, thus authenticating the transmitter 1 as correct.

Therefore, physical measures for increasing the allowable number of write times such as configuring the non-volatile memory to have pages in plurality or configuring each bit to have two cells are not needed, thus suppressing production cost of the transmitter 1.

Although in the first implementation the rolling code is counted up by one, the number by which to count up may be greater than one. Also, although the rolling code backed up in the flash memory 15 of the transmitter 1 is a value obtained by further updating a prescribed number of times (or adding 100 to) the rolling code stored in the RAM 14, it may be a value obtained by further updating a greater number of times than the prescribed number of times. Alternatively, each time the operating switch 12 of the transmitter 1 is operated, the rolling code may be counted down.

Also in the transmitter 51 of the second implementation, the rolling code is written into the flash memory 15 not each time but each predetermined number of times. By this means, the number of times to write into the flash memory 15 can be reduced which has an upper limit to the number of write times. That is, physical measures for increasing the allowable number of write times such as configuring the flash memory 15 to have pages in plurality or configuring each bit to have two cells are not needed, thus suppressing production cost of the transmitter 51.

Note that in the keyless entry system where the transmitter 51 and the receiver 52 communicate with each other thereby updating the rolling codes in cooperation with each other, only when the difference between the rolling codes is at a predetermined value, the transmitter 51 is authenticated as correct. However, because the transmitter 51 has the rolling code stored in the RAM 14, the rolling code may be erased due to the draining, the exchange, or the like of the battery 11. Accordingly, each predetermined number of times that the rolling code stored in the RAM 14 is updated, the rolling code that has been further updated a prescribed number of times is written into the flash memory 15. And if the rolling code stored in the RAM 14 is erased due to the draining, the exchange, or the like of the battery 11, the rolling code stored in the flash memory 15 is written into the RAM 14. By this means, the receiver 52 can authenticate the transmitter 51 as correct with the rolling code restored from the flash memory 15.

In this way, by using the RAM 14, the number of times to write into the flash memory 15 can be reduced. That is, physical measures for increasing the allowable number of write times such as configuring the non-volatile memory to have pages in plurality or configuring each bit to have two cells are not needed, thus suppressing production cost of the transmitter 1. The number of authentication-allowable rolling codes is limited to two, thus much degradation in security level can be prevented.

Also in the second implementation, the rolling code may be counted down.

While in the first and second implementations, upon the reset of the CPU 13 associated with the draining, the exchange, or the like of the battery 11, the rolling code backed up in the flash memory 15 is loaded into the RAM 14, the timing of restoring the rolling code is not limited to this. For example, upon the timing at which the operating switch 12 is pressed, the rolling code in the flash memory 15 and the rolling code in the RAM 14 may be compared and if the difference between the two rolling codes is not within 100, then it is determined that the rolling code in the RAM 14 has been erased and the rolling code in the flash memory 15 may be loaded into the RAM 14.

While the first and second implementations of the present invention have been described, the implementations are provided to facilitate the understanding of the present invention and not intended to limit the invention. It should be understood that various changes and alterations can be made therein without departing from spirit and scope of the invention and that the present invention includes its equivalents.

What is claimed is:

1. A keyless entry system comprising:
a transmitter including
a volatile memory,
an authentication number update section that increases a first number stored in the volatile memory according to rules, and
an authentication number transmit section that transmits the first number by radio; and
a receiver including
a memory that stores a second number;
an authentication number receive section that receives the first number; and
an authenticating section that, if the first number is greater than the second number, outputs a signal to indicate being authenticated as correct and updates the second number to the first number, wherein the transmitter further includes
a non-volatile memory,
a backup section that, each time increase in the first number becomes a multiple of a predetermined number, writes into the non-volatile memory a third number obtained by adding a number no less than the predetermined number to the first number, and
an authentication number restore section that reads out the third number and writes the third number as the first number into the volatile memory.

2. A keyless entry system comprising
a transmitter including
a volatile memory,
an authentication number update section that decreases a first number stored in the volatile memory according to rules, and
an authentication number transmit section that transmits the first number by radio; and
a receiver including
a memory that stores a second number,
an authentication number receive section that receives the first number, and
an authenticating section that, if the first number is less than the second number, outputs a signal to indicate being authenticated as correct and updates the second number to the first number, wherein the transmitter further includes
a non-volatile memory,
a backup section that, each time decrease in the first number becomes a multiple of a predetermined number, writes into the non-volatile memory a third number obtained by subtracting a number no less than the predetermined number from the first number, and
an authentication number restore section that reads out the third number and writes the third number as the first number into the volatile memory.

3. The transmitter used in the keyless entry system according to claim 1, which includes the volatile memory, the authentication number update section, the authentication number transmit section; the non-volatile memory, the backup section, and the authentication number restore section.

4. The receiver used in the keyless entry system according to claim 1, which includes the memory, the authentication number receive section, and the authenticating section.

5. The transmitter used in the keyless entry system according to claim 2, which includes the volatile memory, the authentication number update section, the authentication number transmit section; the non-volatile memory, the backup section, and the authentication number restore section.

6. The receiver used in the keyless entry system according to claim 2, which includes the memory, the authentication number receive section, and the authenticating section.

7. A keyless entry system comprising:
a transmitter including
a volatile memory,
an authentication number transmit section that transmits the first number stored in the volatile memory by radio,
an authentication completion signal receive section that receives an authentication completion signal to indicate being authenticated as correct which has been transmitted thereto by radio in response to the first number transmitted,
an authentication number update section that increases the first number by a predetermined increment in response to the authentication completion signal,
a non-volatile memory,
a backup section that, each time increase in the first number becomes a multiple of a predetermined number, writes into the non-volatile memory a third number obtained by adding the predetermined number to the first number, and
an authentication number restore section that reads out the third number and writes the third number as the first number into the volatile memory; and
a receiver including
a memory that stores a second number,
an authentication number receive section that receives the first number,
an authentication number compute section that computes a fourth number equal to the minimum of possible values of the third number which are greater than the second number and writes the fourth number into the memory,
an authentication completion signal transmit section that, if the first number is greater by the increment than the second number or the fourth number, transmits the authentication completion signal by radio, and
an authenticating section that, if the first number is greater by the increment than the second number or the fourth number, outputs a signal to indicate being authenticated as correct and updates the second number to the first number.

8. A keyless entry system comprising:
a transmitter including
a volatile memory,
an authentication number transmit section that transmits the first number stored in the volatile memory by radio,
an authentication completion signal receive section that receives an authentication completion signal to indicate being authenticated as correct which has been transmitted thereto by radio in response to the first number transmitted,
an authentication number update section that decreases the first number by a predetermined decrement in response to the authentication completion signal,
a non-volatile memory,
a backup section that, each time decrease in the first number becomes a multiple of a predetermined number, writes into the non-volatile memory a third number obtained by subtracting the predetermined number from the first number, and
an authentication number restore section that reads out the third number and writes the third number as the first number into the volatile memory; and
a receiver including
a memory that stores a second number,
an authentication number receive section that receives the first number,
an authentication number compute section that computes a fourth number equal to the maximum of possible values of the third number which are less than the second number and writes the fourth number into the memory,
an authentication completion signal transmit section that, if the first number is less by the decrement than the second number or the fourth number, transmits the authentication completion signal by radio, and
an authenticating section that, if the first number is less by the decrement than the second number or the fourth number, outputs a signal to indicate being authenticated as correct and updates the second number to the first number.

9. The transmitter used in the keyless entry system according to claim 7, which includes the volatile memory, the authentication number transmit section, the authentication completion signal receive section, the authentication number update section, the non-volatile memory, the backup section, and the authentication number restore section.

10. The receiver used in the keyless entry system according to claim 7, which includes the memory, the authentication number receive section, the authentication number compute section, the authentication completion signal transmit section, and the authenticating section.

11. The transmitter used in the keyless entry system according to claim 8, which includes the volatile memory, the authentication number transmit section, the authentication completion signal receive section, the authentication number update section, the non-volatile memory, the backup section, and the authentication number restore section.

12. The receiver used in the keyless entry system according to claim 8, which includes the memory, the authentication number receive section, the authentication number compute section, the authentication completion signal transmit section, and the authenticating section.
